(19) United States
(12) Patent Application Publication
(10) Pub. No.: US 2008/0141051 A1
(43) Pub. Date: Jun. 12, 2008

(54) Apparatus and method for controlling power in a communication system

(75) Inventors: Sung-Won Lee, Seongnam-si (KR); Young-Ky Kim, Seoul (KR); Dae-Seok Kim, Seoul (KR); Joon-Ho Park, Seongnam-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/001,223

(22) Filed: Dec. 11, 2007

(30) Foreign Application Priority Data
Dec. 11, 2006 (KR) 2006-125733

(51) Int. Cl. G06F 1/00

(52) U.S. Cl. 713/323

(57) ABSTRACT

A power control apparatus of a user terminal in a communication system. A transmission module transmits a signal, a reception module receives a signal, and a power supply module performs power supply to modules included in the user terminal under a predetermined control. A control module controls an operation of the power supply module to transition from a Power-ON state to a Power-Active-SAVE state upon detecting a first event causing a transition from the Power-ON state to the Power-Active-SAVE state, and to supply limited power to the control module, the transmission module and the reception module among the modules included in the user terminal.

### CROSS-REFERENCE TO RELATED APPLICATION(S) AND CLAIM OF PRIORITY

This application claims the benefit under 35 U.S.C. §119(a) of a Korean Patent Application filed in the Korean Intellectual Property Office on Dec. 11, 2006 and assigned Serial No. 2006-125733, the disclosure of which is incorporated herein by reference.

### TECHNICAL FIELD OF THE INVENTION

The present invention relates to an apparatus and method for controlling power in a communication system.

### BACKGROUND OF THE INVENTION

Intensive research on the 4th Generation (4G) communication system, or the next generation communication system, is being conducted to support high-speed services in the way of guaranteeing the mobility and various Quality of Service (QoS) classes.

With reference to FIG. 1, a description will now be made of a configuration of a Broadband Wireless Access (BWA) communication system, an example of the next generation communication system.

FIG. 1 schematically illustrates a configuration of a BWA communication system.

Referring to FIG. 1, the BWA communication system includes a user terminal 101, a Radio Access Station (RAS) 103, an Access Control Router (ACR) 107, and servers for providing communication services by means of the ACR 107.

The user terminal 101, for example, notebook computer, Personal Digital Assistance (PDA), mobile phone, Portable Multimedia Player (PMP), digital camera, or the like, can access the BWA communication system and receive communication services therefrom.

The RAS 103 exchanges data with the user terminal 101, and is Internet Protocol (IP)-connected to the ACR 107 via an IP network 105. Further, the RAS 103 performs a radio access processing operation with the user terminal 101 that accesses the communication system, and performs a scheduling and ranging operation for exchanging data with the user terminal 101. The RAS 103 transmits initialization and communication system information for the cell that can receive communication services therefrom to the user terminal 101, and controls inter-sector handover of the user terminal 101 when the user terminal 101 moves between sectors in the cell.

The ACR 107 performs a function of controlling the IP-connected RAS 103, and one ACR 107 can control multiple RASs. In addition, the ACR 107 transmits to the RAS 103 the communication services provided by the communication servers, for example, a VoD/AoD server 111 for providing video and/or audio services, a web server 113 for providing Internet web services, a VoIP/VT server 115 for providing voice and/or image services, and a messenger server 117 for providing Instant Messaging (IM) services, thereby to provide the communication services to the user terminal 101 that has accessed the communication system. Further, the ACR 107 performs authentication, IP address allocation, and routing functions for the user terminal 101 that has accessed the communication system.

The IP networks 105 and 109 process interfacing with the RAS 103, the ACR 107, and the communication servers (i.e., VoD/AoD server 111, web server 113, VoIP/VT server 115, and messenger server 117), thereby forming a network.

In the BWA communication system, the user terminal 101 supports a Power-ON state, a Power-OFF state, and a Power-SAVE state. Here, the Power-ON state indicates the state where power is supplied to all modules included in the user terminal 101. The user terminal 101 in the Power-ON state makes state transition to the-Power-OFF state if the user directly presses a power-related button of the user terminal 101 or if there is no more data transmission or reception within a predetermined time. The Power-OFF state indicates the state where the power supplied to all modules included in the user terminal 101 is interrupted. The user terminal 101 in the Power-ON state can make state transition to the Power-SAVE state, and the use of an operation based on the Power-SAVE state can solve the limited battery capacity problem of the user terminal 101.

However, the user terminal 101, once it enters the Power-SAVE state or the Power-OFF state, cannot receive the communication services before it makes state transition back to the Power-ON state. That is, the user terminal 101 can save its battery capacity in the Power-SAVE state or the Power-OFF state, but cannot transmit a service request or the data to the corresponding user terminal.

### SUMMARY OF THE INVENTION

To address the above-discussed deficiencies of the prior art, it is a primary aspect of the present invention to address at least the problems and/or disadvantages and to provide at least the advantages described below. Accordingly, an aspect of the present invention is to provide an apparatus and method for controlling power in a communication system.

According to one aspect of the present invention, there is provided a power control method of a user terminal in a communication system. The power control method includes transitioning from a Power-ON state to a Power-Active-SAVE state upon detecting a first event causing a transition from the Power-ON state to the Power-Active-SAVE state; and supplying limited power to a control module, a transmission module and a reception module among the modules included therein.

According to another aspect of the present invention, there is provided a power control apparatus of a user terminal in a communication system. The power control apparatus includes a transmission module for transmitting a signal; a reception module for receiving a signal; a power supply module for performing power supply to modules included in the user terminal under a predetermined control; and a control module for controlling an operation of the power supply module to transition from a Power-ON state to a Power-Active-SAVE state upon detecting a first event causing a transition from the Power-ON state to the Power-Active-SAVE state, and to supply limited power to the control module, the transmission module and the reception module among the modules included in the user terminal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 schematically illustrates a configuration of a BWA communication system;

FIG. 2 schematically illustrates a structure of a user terminal according to an embodiment of the present invention;

FIG. 3 schematically illustrates power states supported by a user terminal according to an embodiment of the present invention;

FIG. 4 illustrates a state transition process to a Power-OFF state or a Power-Active-SAVE state of a user terminal in a Power-ON state;

FIG. 5 illustrates a state transition process to a Power-OFF state or a Power-ON state of a user terminal in a Power-Active-SAVE state;

FIG. 6 illustrates a state transition operation to a Power-ON state of a user terminal in a Power-Active-SAVE state according to a first embodiment of the present invention; and

FIG. 7 illustrates a state transition operation to a Power-ON state of a user terminal in a Power-Active-SAVE state according to a second embodiment of the present invention.

### DETAILED DESCRIPTION OF THE INVENTION

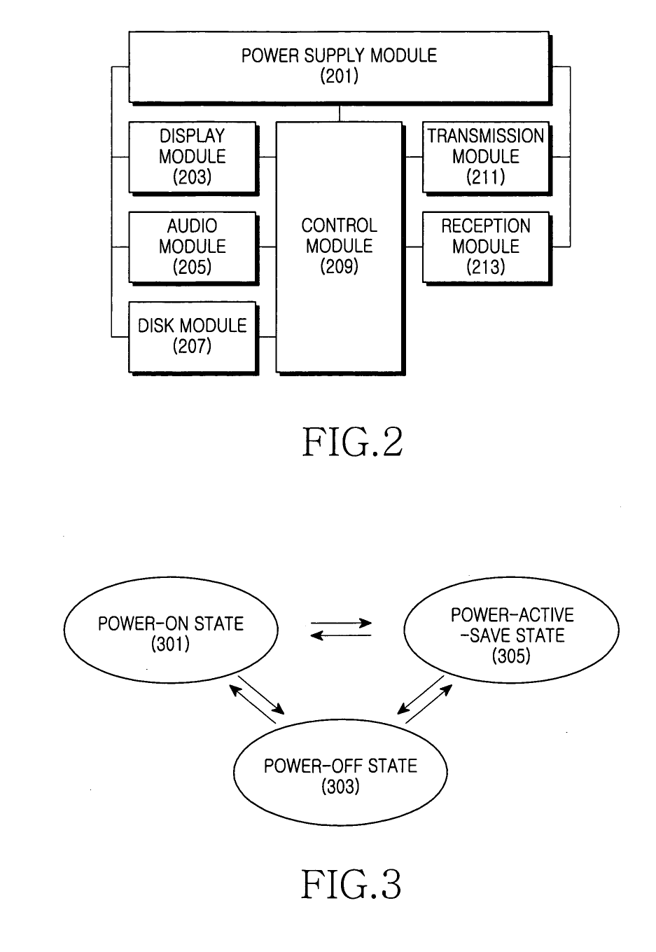

FIGS. 2 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

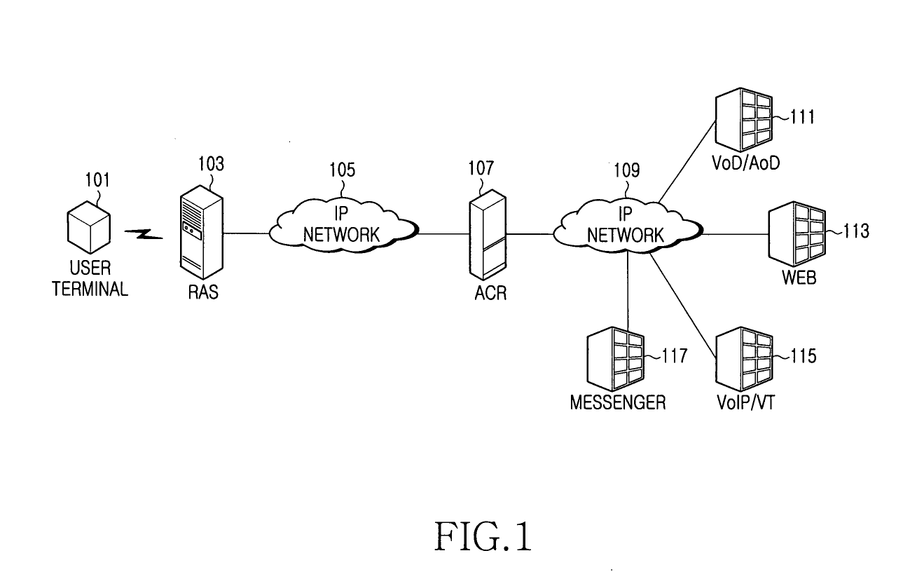

The present invention provides an apparatus and method for controlling power in a communication system, for example, in a Broadband Wireless Access (BWA) communication system. A configuration of the BWA communication system has been described in FIG. 1, so a detailed description thereof will be omitted herein.

With reference to FIG. 2, a description will now be made of a structure of a user terminal according to an embodiment of the present invention.

FIG. 2 schematically illustrates a structure of a user terminal according to an embodiment of the present invention.

Referring to FIG. 2, a user terminal includes a power supply module 201, a display module 203, an audio module 205, a disk module 207, a main controller processor module (hereinafter, referred to as a ‘control module’) 209, a wireless communication transmitter module (hereinafter, referred to as a ‘transmission module’) 211, and a wireless communication receiver module (hereinafter, referred to as a ‘reception module’) 213.

The power supply module 201 supplies power to each of the modules, and the control module 209 controls operations of the modules. The display module 203 displays image data under the control of the control module 209, and the audio module 205 outputs audio data under the control of the control module 209. The disk module 207 stores all data generated in the user terminal. The transmission module 211 provides a data transmission function, and the reception module 213 provides a data reception function.

FIG. 3 schematically illustrates power states supported by a user terminal according to an embodiment of the present invention.

Referring to FIG. 3, the power states supported by the user terminal include a Power-ON state 301, a Power-OFF state 303, and a Power-Active-SAVE state 305.

The Power-ON state 301 means the state where power is supplied to all modules 201, 203, 205, 207, 209, 211 and 213 included in the user terminal. The user terminal in the Power-ON state 301 can make state transition to the Power-OFF state 303 or the Power-Active-SAVE state 305 when it detects that there is no data transmission or reception in the Power-ON state 301 for a predetermined time, or when the user directly inputs the power state using a power-related button.

The Power-OFF state 303 means the state where the power supplied to all modules 201, 203, 205, 207, 209, 211 and 213 included in the user terminal is interrupted. The user terminal in the Power-OFF state 303 can make state transition to the Power-ON state 301 or the Power-Active-SAVE state 305.

The Power-Active-SAVE state 305 is the state where the power is restrictively supplied only to the transmission module 211, the reception module 213 and the control module 209, and in this state, the power supplied to the other modules except for the transmission module 211, the reception module 213 and the control module 209 is interrupted. The amount of power supplied to the transmission module 211, the reception module 213 and the control module 209 is limited to the minimum amount of power needed to decode a message received from the communication system. Therefore, the user terminal in the Power-Active-SAVE state can minimize its battery consumption.

The user terminal in the Power-Active-SAVE state 305 can make a state transition to the Power-ON state 301 or the Power-OFF state 303. A description will first be made of a state transition to the Power-OFF state 303 of the user terminal in the Power-Active-SAVE state 305. The user terminal in the Power-Active-SAVE state 305 transitions to the Power-OFF state 303 when the user directly inputs the power state using the power-related button, or when the user terminal detects that there is no more data transmission or reception within a predetermined time.

Next, a description will be made of a state transition to the Power-ON state 301 of the user terminal in the Power-Active-SAVE state 305. The user terminal in the Power-Active-SAVE state 305 can transition to the Power-ON state 301 when the user directly inputs the power state using the power-related button, or when the user terminal receives a message, for example, paging message, from the communication system. Here, the paging message is a message for requesting the user terminal in the Power-Active-SAVE state 305, which has released its all wireless connections, to resume the wireless communication connection.

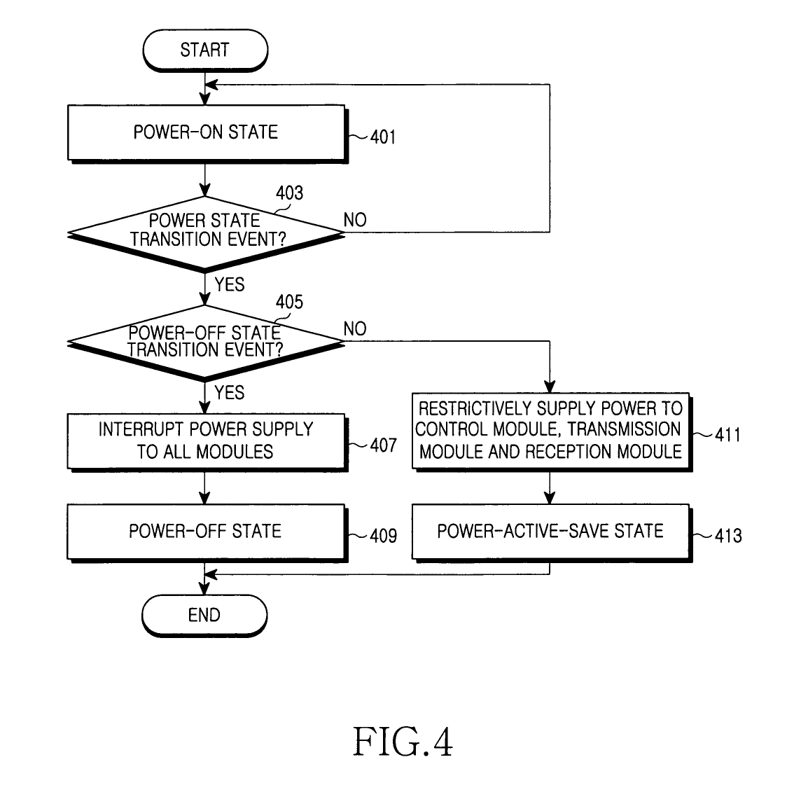

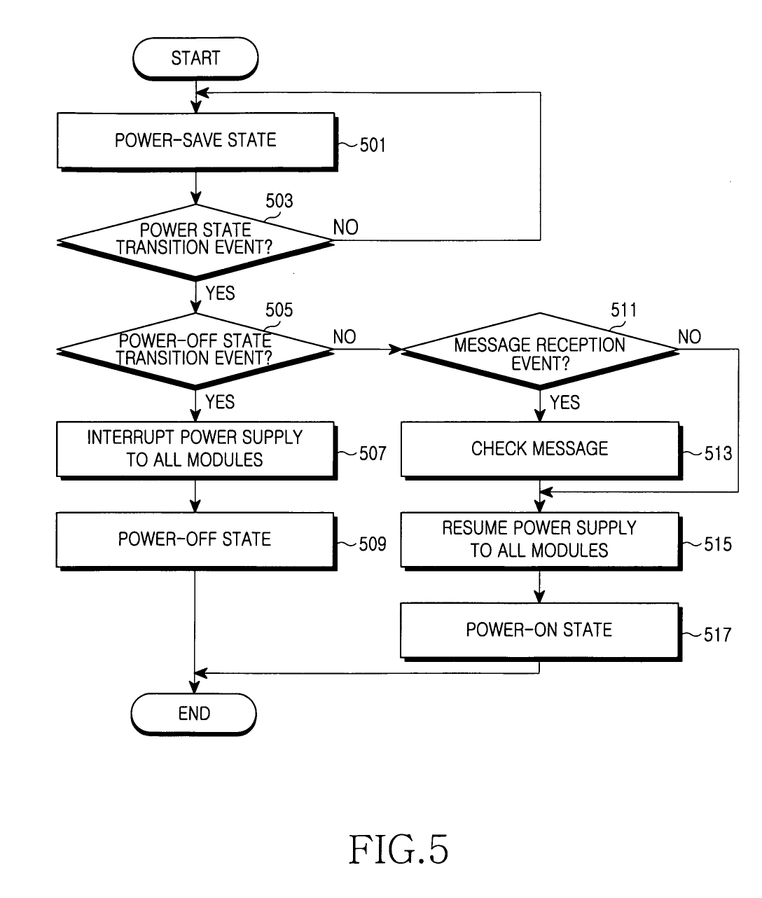

Although the paging message is used herein as a message for requesting the user terminal in the Power-Active-SAVE state 305, which has released its all wireless connections, to resume the wireless communication connection, by way of example, the paging message can be replaced with any first message for resuming wireless communication connection for data transmission to the user terminal. With reference to FIGS. 4 and 5, a description will now be made of a power state transition process of the user terminal.

FIG. 4 illustrates a state transition process to a Power-OFF state or a Power-Active-SAVE state of a user terminal in a Power-ON state.

A user terminal is in a Power-ON state in step 401, and determines in step 403 whether a power state transition event has occurred. If it is determined in step 403 that the power state transition event has not occurred, the user terminal returns to step 401 and keeps the current Power-ON state. However, if the power state transition event has occurred, the user terminal determines in step 405 whether the power state transition event that occurred is a Power-OFF state transition event. If it is determined in step 405 that the power state transition event that occurred is a Power-OFF state transition event, the user terminal proceeds to step 407 where it interrupts the power supply to its all modules. Thereafter, in step 409, the user terminal keeps the Power-OFF state.

However, if it is determined in step 405 that the power state transition event that occurred is not a Power-OFF state transition event (i.e., if the power state transition event is a Power-Active-SAVE state transition event), the user terminal proceeds to step 411 where it interrupts the power supply to all modules except for a control module, a transmission module and a reception module, and restrictively supplies the power only to the control module, the transmission module and the reception module. Thereafter, in step 413, the user terminal keeps the Power-Active-SAVE state.

FIG. 5 illustrates a state transition process to a Power-OFF state or a Power-ON state of a user terminal in a Power-Active-SAVE state.

A user terminal is in a Power-Active-SAVE state in step 501, and determines in step 503 whether a power state transition event has occurred. If it is determined in step 503 that a power state transition event has not occurred, the user terminal returns to step 501 and keeps the current Power-Active-SAVE state. However, if a power state transition event has occurred, the user terminal determines in step 505 whether the power state transition event that occurred is a Power-OFF state transition event. If it is determined in step 505 that the power state transition event that occurred is a Power-OFF state transition event, the user terminal proceeds to step 507 where it interrupts the power supply to its all modules. Thereafter, in step 509, the user terminal keeps the Power-OFF state. The transition from the Power-Active-SAVE state to the Power-OFF state of the user terminal occurs when the user directly inputs the power state using the power-related button or when the user terminal detects that there is no more data transmission or reception within a predetermined time.

However, if it is determined in step 505 that the power state transition event that occurred is not the Power-OFF state transition event, the user terminal determines in step 511 whether the power state transition event that occurred is a message reception event. The message reception event is an event that occurs when a paging message is received. If it is determined in step 511 that the power state transition event that occurred is a message reception event, the user terminal proceeds to step 513 where it checks the received paging message. Thereafter, the user terminal resumes the power supply to its all modules in step 515, and keeps the Power-ON state in step 517.

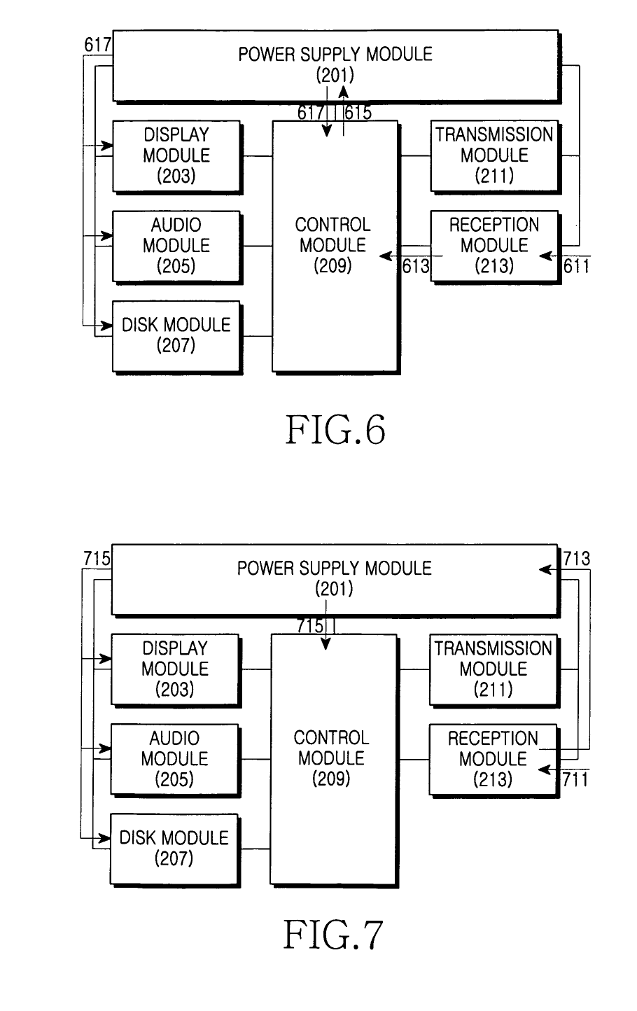

However, if it is determined in step 511 that the power state transition event that occurred is not the message reception event, the user terminal resumes the power supply to its all modules in step 515, and keeps the Power-ON state in step 517. Next, with reference to FIGS. 6 and 7, a description will be made of a user terminal that transitions from the Power-Active-SAVE state to the Power-ON state upon receipt of the paging message. A structure of the user terminal has been described in FIG. 2, so a detailed description thereof will be omitted herein.

FIG. 6 illustrates a state transition operation to a Power-ON state of a user terminal in a Power-Active-SAVE state according to a first embodiment of the present invention.

Referring to FIG. 6, a reception module 213 receives a paging message from a wireless communication network (Step 611), and transfers a signal indicating the power supply resumption based on the receipt of the paging message to a control module 209 (Step 613). The control module 209 transfers the power supply resumption signal received from the reception module 213 to a power supply module 201 (Step 615). Upon recognizing the communication resumption of the corresponding user terminal from the wireless communication network in this way, the power supply module 201 resumes the power supply to the power-interrupted modules (i.e., the display module 203, the audio module 205, the disk module 207 and the control module 209) (Step 617).

FIG. 7 illustrates a state transition operation to a Power-ON state of a user terminal in a Power-Active-SAVE state according to a second embodiment of the present invention.

Referring to FIG. 7, a reception module 213 receives a paging message from a wireless communication network (Step 711), and transfers a signal indicating the power supply resumption based on the receipt of the paging message to a power supply module 201 (Step 713). Upon recognizing the communication resumption of the corresponding user terminal from the wireless communication network in this way, the power supply module 201 resumes the power supply to the power-interrupted modules (i.e., the display module 203, the audio module 205, the disk module 207 and the control module 209) (Step 715).

As is apparent from the foregoing description, the present invention can efficiently perform power control on the user terminal in the communication system. That is, the present invention can enable transmission/reception of the communication services provided in the communication system with the minimized power consumption. In addition, the present invention effectively controls the battery even when the Always-ON services such as the voice service and IM service are performed in the user terminal, thereby facilitating provision of the Always-ON services.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A power control method of a user terminal in a communication system, the method comprising:
transitioning from a Power-ON state to a Power-Active-SAVE state upon detecting a first event causing a transition from the Power-ON state to the Power-Active-SAVE state; and
controlling to supply limited power to a control module, a transmission module and a reception module among the modules included therein.

2. The power control method of claim 1, wherein the limited power is the minimum power needed to decode a message received from the communication system.

3. The power control method of claim 1, wherein the first event occurs when at least one of: i) a user directly inputs a power state using a power-related button; and ii) there is no data transmission and no data reception for a predetermined time.

4. The power control method of claim 1, further comprising:
transitioning from the Power-Active-SAVE state to the Power-ON state upon detecting a second event causing a transition from the Power-Active-SAVE state to the Power-ON state; and
controlling to supply power to all modules included therein.

5. The power control method of claim 4, wherein the second event occurs when a user directly inputs a power state using a power-related button or receives a message from the communication system.

6. The power control method of claim 5, wherein the message is a message for requesting the user terminal in the Power-Active-SAVE state to resume the wireless communication connection.

7. A power control apparatus of a user terminal in a communication system, the apparatus comprising:
a transmission module for transmitting a signal;
a reception module for receiving a signal;
a power supply module for performing power supply to modules included in the user terminal under a predetermined control; and
a control module for controlling an operation of the power supply module to transition from a Power-ON state to a Power-Active-SAVE state upon detecting a first event causing a transition from the Power-ON state to the Power-Active-SAVE state, and to supply limited power to the control module, the transmission module and the reception module among the modules included in the user terminal.

8. The power control apparatus of claim 7, wherein the limited power is the minimum power needed to decode a message received from the communication system.

9. The power control apparatus of claim 7, wherein the first event occurs when at least one of: i) a user directly inputs a power state using a power-related button; and ii) there is no data transmission and no data reception for a predetermined time.

10. The power control apparatus of claim 7, wherein the control module controls the power supply module to transition from the Power-Active-SAVE state to the Power-ON state upon detecting a second event causing a transition from the Power-Active-SAVE state to the Power-ON state, and to supply power to all modules included in the user terminal.

11. The power control apparatus of claim 10, wherein the second event occurs when a user directly inputs a power state using a power-related button or receives a message from the communication system.

12. The power control apparatus of claim 11, wherein the message is a message for requesting the user terminal in the Power-Active-SAVE state to resume the wireless communication connection.
